(19) United States
(12) Patent Application Publication
(10) Pub. No.: US 2026/0064421 A1
(43) Pub. Date: Mar. 5, 2026

(54) ATOMIC COMPARE AND SWAP USING MICRO-OPERATIONS

(71) Applicant: Akeana, Inc., Santa Clara, CA (US)

(72) Inventors: Ricardo Ramirez, Sunnyvale, CA (US); Abhijit Sil, Dublin, CA (US)

(73) Assignee: Akeana, Inc., Santa Clara, CA (US)

(21) Appl. No.: 19/311,190

(22) Filed: Aug. 27, 2025

Related U.S. Application Data
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.

(51) Int. Cl. G06F 9/38; G06F 9/30

(52) U.S. Cl. CPC G06F 9/3812; G06F 9/30087; G06F 9/30109

(57) ABSTRACT

A processor core is accessed. The processor core supports atomic memory operations. The atomic memory operations include multi-operand operations. A compare and swap (CAS) instruction is issued in the processor core. The CAS instruction necessitates three source operands. One of the source operands comprises a destination register. The CAS instruction is split into a plurality of micro-operations. A first value is written from a memory location indicated by a first source operand into a temporary register. A memory word location addressed by a second source operand is accessed using a second micro-operation. The first micro-operation and the second micro-operation are interlocked. Contents of the memory word location are compared. A third source operand is stored to the memory word location addressed by the second source operand. The storing is based on a match of the comparing.

### RELATED APPLICATIONS

This application claims the benefit of U.S. provisional patent applications “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, and “AI Compute Clusters With Noncoherent Shared SRAM” Ser. No. 63/854,877, filed Jul. 31, 2025.

Each of the foregoing applications is hereby incorporated by reference in its entirety.

### FIELD OF ART

This application relates generally to instruction execution and more particularly to atomic compare and swap using micro-operations.

### BACKGROUND

The many electronic devices in widespread use today are enabled by powerful processors. Popular devices, including smartphones and other handheld devices, computers, smart appliances, and smart homes, all contain at least one processor. In order to design faster devices, the performance of the processors is boosted, enabling common tasks such as opening apps, loading web pages, etc. to occur at a rapid pace. These improvements enhance user experience and productivity significantly. Faster processors support multiple tasks simultaneously, enabling better handling of tasks such as editing large files or streaming high-definition media. Furthermore, gaming systems are enhanced by faster processors. Video games require great processing power to render complex graphics, perform simulations, and enable AI features. Faster processors enable increased video frame rates, reduced controller response lag, and enhanced gaming experience. Moreover, AI and machine learning applications require significant computational power. Faster processors optimized for AI applications accelerate AI model training and inference tasks.

The foremost processor categories include Complex Instruction Set Computer (CISC) types and Reduced Instruction Set Computer (RISC) types. A CISC processor instruction may execute various operations. The operations can include loading from and storing to memory, arithmetic operations, logical operations, and so on. In a RISC processor, the instruction sets are smaller than the CISC instruction sets and may execute several operations in a pipelined manner. Pipeline stages can include fetch, decode, and execute. Each of these pipeline stages may take one clock cycle, and thus, the pipelined operation can allow RISC processors to operate on more than one instruction per clock cycle.

Integrated circuits (ICs) including processors are designed using a Hardware Description Language (HDL). Example HDLs include Verilog, VHDL, etc. HDLs support behavioral descriptions and register transfer, gate, and switch level logic. HDLs enable designers to define system levels with varying detail. Behavioral level logic enables sequential instruction execution, while register transfer level logic describes data transfer between registers using a clock and gate level logic. An HDL enables text models that describe or express logic circuits. The models can be processed by a synthesis program, then tested using a simulation or emulation program. The design can include Register Level Transfer (RTL) abstractions that define the synthesizable data that is fed into a logic synthesis tool that creates the gate-level abstraction of the design used for downstream implementation operations.

The HDL tools enable the design and implementation of processors and other integrated circuits such as System-on-Chip (SoC) integrated circuits. SoC integrated circuits are highly versatile and find applications in a wide range of electronic devices and systems. These integrated circuits are designed to incorporate multiple components and functionalities onto a single chip, making them compact, power efficient, and cost effective. Processor performance enables a wide variety of applications, including data processing, virtualization, content creation, and security applications, to name a few. Thus, processer performance continues to be an important factor in the development of new systems and technologies.

### SUMMARY

The performance and utility of devices directly correlates to the performance of one or more processors within the devices. The devices can include widely recognized ones and specialized ones. Widely recognized, common devices in which one or more processors are found include mobile and handheld devices, wearable devices, consumer electronics, automotive electronics, edge computing, and Internet of Things (IOT), to name a few. The processors can be classified based on their instruction sets, where the instruction sets include complex instruction sets or reduced instruction sets. For the class of processors that includes the RISC processors, instructions for the processors can be split into sets of micro-operations. The sets of micro-operations can be executed atomically, thereby enabling synchronization of two or more processing threads that are executing. In embodiments, the execution of the micro-operations can be based on efficient instruction or operation pipelines. The pipelines play a critical role in the overall processor performance and functionality of the processors. The operations that can utilize the efficient pipelines include Atomic Compare And Swap (AMOCAS) instructions associated with RISC instruction sets. The AMOCAS instruction can be split into a series of micro-operations, where the micro-operations can be provided to the pipeline for execution. The AMOCAS operations can include word, double-word, and quad-word variations to support various data widths. The efficient operation of the pipelines allows for the concurrent execution of multiple micro-operations, yielding a higher instruction throughput.

Techniques for instruction execution are disclosed. A processor core is accessed. The processor core supports atomic memory operations. The atomic memory operations include multi-operand operations. A compare and swap (CAS) instruction is issued in the processor core. The CAS instruction necessitates three source operands. One of the source operands comprises a destination register. The CAS instruction is split into a plurality of micro-operations. A first value is written from a memory location indicated by a first source operand into a temporary register. A memory word location addressed by a second source operand is accessed using a second micro-operation. The first micro-operation and the second micro-operation are interlocked. Contents of the memory word location are compared. A third source operand is stored to the memory word location addressed by the second source operand. The storing is based on a match of the comparing.

A processor-implemented method for instruction execution is disclosed comprising: accessing a processor core, wherein the processor core supports atomic memory operations, and wherein the atomic memory operations include multi-operand operations; issuing a compare and swap (CAS) instruction, in the processor core, wherein the CAS instruction includes three source operands, and wherein one of the source operands comprises a destination register; splitting the CAS instruction into a plurality of micro-operations; writing a first value from the destination register indicated by a first source operand into a temporary register using a first micro-operation; accessing a memory word location addressed by a second source operand using a second micro-operation; interlocking the first micro-operation and the second micro-operation; comparing the temporary register to contents of the memory word location addressed by a second source operand, based on the interlocking; and storing a third source operand to a memory word location addressed by the second source operand, based on a match of the comparing. In embodiments, the first micro-operation comprises a Move To Temporary Register (MVTT) micro-operation. In embodiments, the second micro-operation comprises a Compare And Swap (CAS) micro-operation. In embodiments, the interlocking prevents dispatch of the second micro-operation, based on the MVTT micro-operation being completed. In embodiments, the MVTT micro-operation being retired ensures the temporary register has been successfully updated by the first micro-operation. Some embodiments comprise inhibiting dispatch of micro-operations supporting an additional compare and swap instruction, based on the CAS micro-operation being completed.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for atomic compare and swap using micro-operations.

FIG. 2 is a flow diagram for additional data access handling.

FIG. 3 is a system block diagram for atomic compare and swap using micro-operations.

FIG. 4 illustrates example AMOCAS.W setup and implementation pseudocode.

FIG. 5 shows example AMOCAS.D and AMOCAS.Q implementation setup pseudocode.

FIG. 6 illustrates example AMOCAS.D and AMOCAS.Q implementation execution pseudocode.

FIG. 7 is a block diagram for a multicore processor.

FIG. 8 is a block diagram for a pipeline.

FIG. 9 is a system diagram for atomic compare and swap using micro-operations.

### DETAILED DESCRIPTION

Techniques for atomic compare and swap using micro-operations are disclosed. A compare and swap (CAS) instruction is issued for execution on a processor core. The compare and swap instruction provides an atomic operation that enables reading from memory and writing to memory. The CAS instruction enables a “mutual exclusion” technique that can prevent or delay a write operation to a memory location until processes that read from the location are able to access the data stored at the memory location. The mutual exclusion technique enables synchronization between software processes executing on a processor core, a processor, and so on. The CAS instruction can necessitate one or more execution cycles, where the execution cycles can include reading from and writing to data storage. The execution cycles can further include cycles required for process synchronization. The processor core can split the CAS instruction into a plurality of micro-operations, where the micro-operations can be provided to a load/store element included in the processor core. The micro-operations include writing a value from memory into a temporary register. The value in memory is indicated by an operand associated with the CAS instruction. The value can include a single word, a doubleword, a quadword, and so on. The doubleword and the quadword can be stored in two or more temporary registers associated with a register pair. The contents of the temporary register are compared to the contents of a destination register. If the contents of the temporary register and the destination match, a second value associated with a second operation is assigned to the memory location indicated by the first source operand. Otherwise, the contents of the temporary register are stored in the destination register.

Compare and swap instructions can be present in instruction set architectures (ISAs). The CAS instruction can, with a single instruction, require many individual operations to complete the single instruction. For example, CAS instructions can involve several steps that can include loading from memory, storing to temporary registers and pairs of temporary registers, comparing contents of one or more temporary registers with the contents of a destination register, assigning a second value associated with a second source to the first source operation memory location, and storing temporary register contents to the destination register. The storing step or steps can include storing a first value from a memory location to a temporary register. The amount of data that is stored to one or more temporary registers is dependent upon a number of data bytes, where the number of data bytes represents a “data size” of the data that is stored. The data size can include a single word, a doubleword, a quadword, and so on. When the data size is greater than single word, an offset can be added to the memory address associated with a first operand of the CAS instruction. In a usage example, the offset of the additional memory location is four bytes beyond the address of the memory location for a doubleword CAS instruction. In a second usage example, the offset of the additional memory location is eight bytes beyond the address of the memory location for a quadword CAS instruction.

Extensions such as atomic operation extensions can be enabled for a processor architecture such as a RISC-V™ processor core. The atomic operation extensions can include splitting a compare and swap (CAS) instruction into a series of micro-operations and initiating execution of the series of micro-operations. By executing the series of micro-operations atomically, the micro-operations appear to execute “all at once.” The execution of the micro-operations atomically enables synchronization among threads executing on a processor core. The micro-operations can include a variety of operations that support the compare and swap instruction. The micro-operations include storing a first value from a memory location indicated by a first source operand associated with the CAS instruction into a temporary register. The micro-operations include comparing contents of the temporary register to contents of a destination register. The destination register is indicated by an operand associated with the CAS instruction. The comparing is based on a bit-wise comparison. The micro-operations include assigning a second value of a second source operand to the memory location indicated by the first source operand, based on a match of the comparing contents. A match can indicate that a first value loaded from memory has been provided to one or more operations that required it and that the contents of the memory can be updated. A mismatch can also occur. The micro-operations include storing the contents of the temporary register to the destination register, based on a mismatch of the comparing contents. A mismatch can indicate that the first value loaded from the memory location has not yet been fully provided to one or more operations. The first value can remain unchanged.

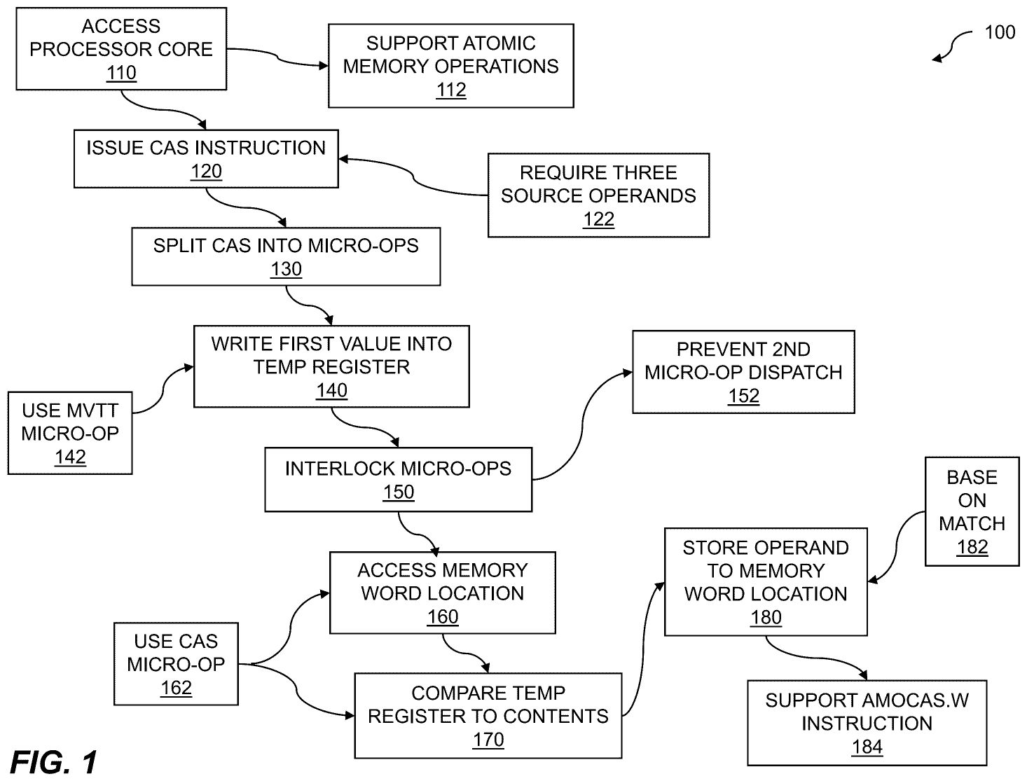

FIG. 1 is a flow diagram for atomic compare and swap using micro-operations. The flow 100 includes accessing a processor core 110. The processor core can be included on a multi-processor chip, an application specific integrated circuit (ASIC), a system-on-a-chip (SOC), and so on. The processor core can execute instructions that are part of an instruction set architecture (ISA) such as X86, ARM, and so on. In embodiments, the processor core can support a RISC-V™ architecture. In the flow 100, the processor core supports atomic memory operations 112. The atomic memory operations can include memory read or load, memory write or store, data comparison, and so on. In embodiments, the atomic memory operations include multi-operand operations. The multiple operands can include a first source operand, a second source operand, a destination operand, and so on. The source operands can be used for a variety of purposes. In embodiments, the first source operand can provide address alignment based on an operand size of the CAS instruction. In other embodiments, a RISC-V™ architecture can include atomic compare and swap extensions. The atomic compare and swap extensions can be included in the processor core. In embodiments, the atomic compare and store extensions enable the use of micro-operations. The atomic compare and swap instructions can be based on various data sizes such as single words, doublewords, quadwords, etc. The processor core can include an execution pipeline, wherein the execution pipeline is configured to execute micro-operations. Discussed below, the compare and swap instructions can be split into micro-operations for execution.

The flow 100 includes issuing a compare and swap (CAS) instruction 120 in the processor core. The CAS instruction can be issued to enable execution synchronization between two or more threads, processes, and so on executing on the processor core. The CAS instruction can require a plurality of execution cycles to complete. In the flow 100, the CAS instruction necessitates three source operands 122, wherein one of the source operands comprises a destination register. The remaining two source operands can include a first source operand and a second source operand. The first source operand and the second source operand can include addresses associated with memory locations. The memory locations can include locations within a cache, a shared local memory, a system memory, and so on. The CAS instruction that is issued can be based on a program counter associated with the processor core. The plurality of execution cycles can be based on architectural cycles associated with the processor core, system clock cycles, processor core clock cycles, etc.

The flow 100 includes splitting the CAS instruction 130 into a series of micro-operations. A CAS instruction can be split into two or more micro-operations. The number of micro-operations can include a power of two number or a non-power of two number. The splitting can be accomplished using an element such as a micro-operation sequencer within a decode unit of the processor core. The splitting by the micro-sequencer can be accompanied by a variety of techniques that can keep track of the micro-operations. In embodiments, the plurality of micro-operations can be issued to a single load issue queue. The load-store unit can include an element associated with the processor core. As discussed above, the micro-operations can include loading, storing, comparing, and so on. The micro-operations can be executed. In embodiments, the plurality of micro-operations can be performed atomically. The plurality of micro-operations can be performed within the load-store unit, by the processor core, etc.

The flow 100 includes writing a first value into a temporary register 140 from a memory location indicated by a first source operand. The first source operand can be the compare value to be used for the CAS instruction that is being executed by the processor. The first source operand can be contained in the destination operand of the CAS instruction (recall that an atomic compare and swap instruction has three operands) and can be designated “rsd.” The value of rsd can be designated “X(rsd).” As discussed later, additional temporary registers can be used to support doubleword CAS instructions in a word-architected (32-bit) processor environment and quadword CAS instructions in a doubleword-architected (64-bit) processor environment. In embodiments, the first micro-operation can include a Move To Temporary Register (MVTT) micro-operation 142. The first micro-operation can implicitly identify the temporary register it will be using.

The flow 100 includes interlocking the first micro-operation and the second micro-operation 150. The interlocking can comprise a post-MVTT synchronization behavior that prevents the dispatch and/or the issue of the second micro-operation 152 until the (final) MVTT micro-operation is retired or completed. This ensures that any/all involved temporary registers have been updated before the ensuing micro-operation executes. The flow 100 includes accessing a memory word location 160 addressed by a second source operand. The accessing a memory word location can be performed by a second micro-operation. The second micro-operation can comprise a compare and swap (CAS) micro-operation. The second source operand can be designated “rs1.” The value of the second source operand can be designated “X(rs1),” and the value of the second source operand can indicate an address from which to obtain the value to be compared to the compare value mentioned above. The value to be compared can thus be designated mem [X(rs1)]. The accessing a memory word location can use a CAS micro-operation 162, which can also perform the ensuing comparing and at least part of the ensuing storing, which are described below. The flow 100 includes comparing contents 170 of the temporary register to contents of a destination register. The comparing contents can be based on a bit-wise comparison, a byte-wise comparison, and so on. The comparing contents can be based on a half-word, word, doubleword, quadword, etc. The comparing contents can be based on comparing a number of high-order bits, a number of low-order bits, and the like. The comparing can use a CAS micro-operation 162 to implement part of the atomic CAS instruction. The comparing can be initiated, based on the interlocking micro-operations 150 being complete. Some embodiments comprise inhibiting dispatch of micro-operations supporting an additional compare and swap instruction, based on the CAS micro-operation being completed. This can prevent two or more AMOCAS instructions from interfering with each other. Thus, in embodiments, the inhibiting dispatch of micro-operations supporting the additional compare and swap instruction maintains integrity of the temporary register. And in embodiments, the interlocking and the inhibiting enable atomicity of the micro-operations comprising the compare and swap instruction.

The flow 100 includes storing a third source operand to the memory word location 180 addressed by a second source operand. The storing can be based on a match 182 of the comparing contents. If a match occurs between the contents of the memory location and the contents of the temporary register, then the value of the third source operand is stored to the memory location indicated by the original address specified by the second source operand. The storing the third source operand can be the culmination of an Atomic Compare And Swap (AMOCAS) Word (AMOCAS.W) instruction 184. The atomicity of the AMOCAS instruction is preserved by the interlocking and by preventing an additional AMOCAS instruction from being dispatched until the current AMOCAS instruction completes. In embodiments the splitting, the storing a first value, the comparing, the assigning, and the storing the contents comprise an Atomic Memory Operation Compare And Swap Word (AMOCAS.W) instruction. The AMOCAS. W instruction can include a plurality of micro-operations. Since the AMOCAS.W instruction is an atomic instruction, the instruction either completes or does not complete, but it is not interrupted by other instructions. To summarize, an AMOCAS.W instruction atomically loads a 32-bit data value from the address in the second source operand, compares the loaded value to the 32-bit value held in the first source operand, and if the comparison is bitwise equal, stores the 32-bit value held in the third source operand to the original address in the second source operand. In addition, the value loaded from memory is placed into the destination register, herein described as the first source operand. Additional versions of the AMOCAS instruction can be used to operate on greater than word data. In embodiments, an instruction that operates on doubleword data can include an AMOCAS.D (doubleword) instruction. An AMOCAS instruction that operates quadword data can include an AMOCAS.Q (quadword) instruction.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

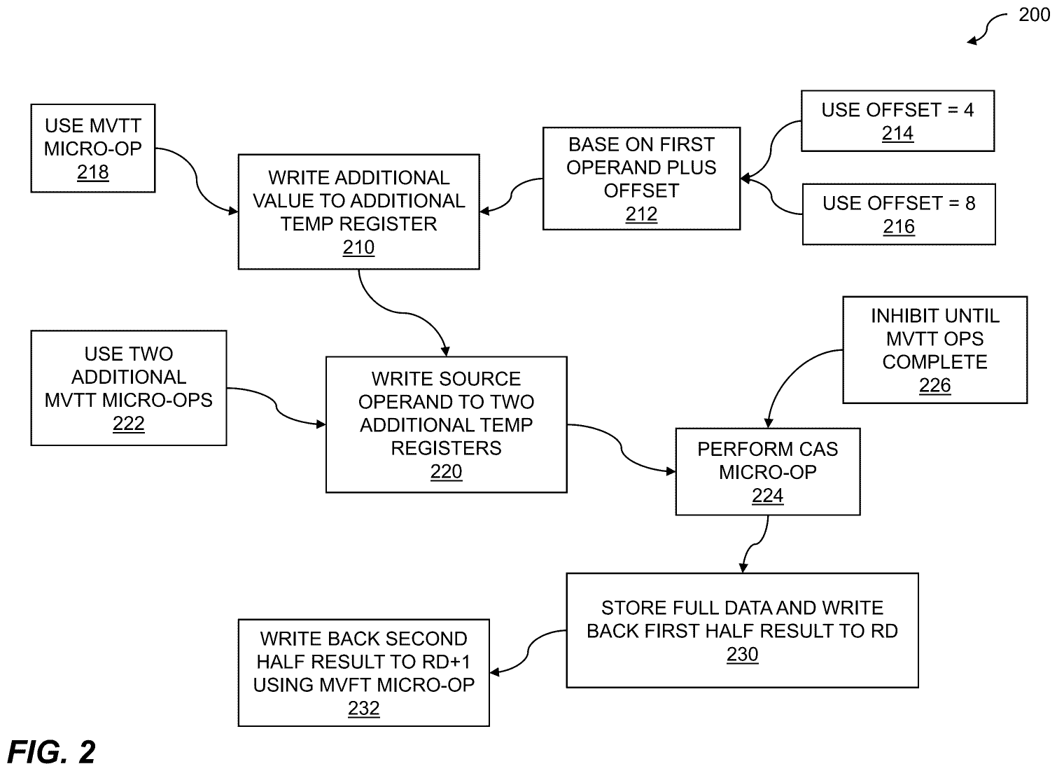

FIG. 2 is a flow diagram for additional data access handling. The additional data can be accessed based on the size, precision, and so on of the data. The additional data can include a second half of a double-sized data word, the remaining three quarters of a quad-sized data word, and so on. The additional data access handling enables a variety of data precisions and/or data widths for data associated with atomic compare and swap operations using micro-operations in both 32-bit and 64-bit processor architectures. A processor core is accessed. The processor core can be based on a variety of design approaches and processor architectures including multiprocessor architectures. The processor core can include a RISC-V™ processor. The processor core supports atomic memory operations, and the atomic memory operations include multi-operand operations. A compare and swap (CAS) instruction is issued in the processor core. The CAS instruction necessitates three source operands. One of the source operands comprises a destination register. The CAS instruction is split into a plurality of micro-operations. A first value is written from a memory location indicated by a first source operand into a temporary register. A memory word location addressed by a second source operand is accessed using a second micro-operation. The first micro-operation and the second micro-operation are interlocked. Contents of the memory word location are compared. A third source operand is stored to the memory word location addressed by the second source operand. The storing is based on a match of the comparing.

The flow 200 can include writing an additional value to an additional temporary register 210. The additional value can be the contents of the memory location associated with the first source operand, but offset by an appropriate amount. In other words, when a 32-bit system accesses a doubleword, or a 64-bit system accesses a quadword, the second half of the data value associated with an address can be accessed using a second operation. The second operation can access data based on the first source operand plus an offset 212. The offset can be four bytes 214 for a doubleword and eight bytes 216 for a quadword. In embodiments, the first source operand can provide address alignment based on an operand size of the CAS instruction. The additional memory location can be adjacent to the memory location associated with the first value, but offset by four bytes or eight bytes. In embodiments, the memory location indicated by the first source operand plus an offset is based on the CAS instruction comprising a CAS instruction operating on greater than word data, such as a doubleword or a quadword. The writing an additional value to an additional temporary register can be performed using an additional Move To Temporary Register (MVTT) micro-operation 218. In a usage example, if the offset is four bytes, the second value can include four additional bytes for a total of eight bytes. The eight bytes represent a double-precision value or “doubleword.” In a second usage example, if the offset is eight bytes, the second value can include an additional eight bytes for a total of sixteen bytes. The sixteen bytes represent a quad-precision value or a “quadword.”

The flow 200 includes writing the source operand to two additional temporary registers 220. The writing to the two additional temporary registers can use two additional Move To Temporary Register (MVTT) micro-operations 222. Thus, the MVTT micro-operation, the additional MVTT micro-operation, and the two further additional micro-operations can comprise four MVTT micro-operations to write two “chunks” of compare data and two “chunks” of memory word data addressed by a second source operand to two pairs of temporary registers. The temporary registers for storing the two “chunks” of compare data (eight bytes for a doubleword in a 32-bit architecture or sixteen bytes for a quadword in a 64-bit architecture) can be designated CMP0, CMP1, SWP0, and SWP1 for the pair of compare registers and the pair of swap registers, respectively. In embodiments, the writing a first value and the writing an additional value comprise two Move To Temporary register (MVTT) micro-operations. Some embodiments comprise following the writing a first value and the writing a second value with two additional MVTT micro-operations. In embodiments, the two additional MVTT micro-operations write a split third source operand into two additional temporary registers. All the MVTT micro-operations can be executed in any order based on their source availability, but the compare and swap (CAS) micro-operation, described below, can only start after all the MVTT operations have completed.

The flow 200 further includes performing a compare and swap (CAS) micro-operation 224 as the designated second micro-operation, although additional MVTT micro-operations have been included in the first micro-operation. The CAS micro-operation can operate on the first value and the second value. The CAS micro-operation can accomplish comparing, assigning, storing, and so on as described previously. The CAS micro-operation can be inhibited until the additional MVTT micro-operations have completed 226. This additional post-synchronization can ensure integrity and atomicity of the AMOCAS instruction. In embodiments, the CAS micro-operation is inhibited until the two additional MVTT micro-operations have completed. The CAS micro-operation can store the full data and write back the first half of the result to the destination register (rd) 230. The full store data includes both the first and second halves. The write-back, however, is only for the first half of the result. The first half of the result value can be stored directly by the CAS micro-operation. The second half of the result value can be written to a temporary register, which can be designated LDR. The second half of the result value can be stored by a concluding Move From Temporary Register (MVFT) micro-operation, which takes the second half result and writes it to the destination register plus 1 address (rd+1) 232. The MVFT is not issued until the CAS micro-operation has completed. In embodiments, the MVFT micro-operation ensures successful completion of the CAS micro-operation before execution of the MVFT micro-operation. In embodiments, the MVFT micro-operation uses a further additional temporary register.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

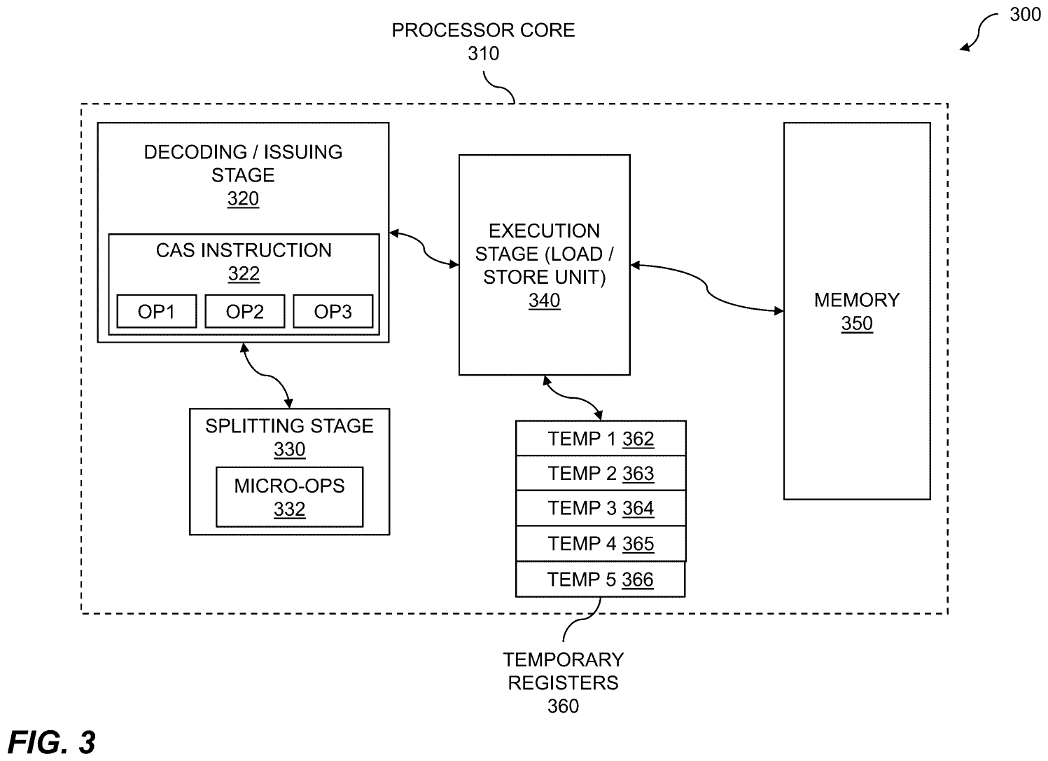

FIG. 3 is a system block diagram for atomic compare and swap using micro-operations. Described previously and throughout, compare and swap (CAS) instructions can be used to achieve synchronization between and among multiple execution threads. The instruction can be used to compare a value to the contents of a memory location. If the value and the contents of the memory location are equal, then the contents of the memory location can be changed by storing a new value to the memory location. The CAS instruction can be split into a plurality of micro-operations to create an Atomic Memory Operation Compare And Swap (AMOCAS) instruction. The atomic compare and swap using microinstructions can be executed. A processor core is accessed. The processor core can be based on a variety of design approaches and processor architectures such as a RISC-V™ processor. The processor core supports atomic memory operations, and the atomic memory operations include multi-operand operations. A compare and swap (CAS) instruction is issued in the processor core. The CAS instruction necessitates three source operands. One of the source operands comprises a destination register. The CAS instruction is split into a plurality of micro-operations. A first value is written from a memory location indicated by a first source operand into a temporary register. A memory word location addressed by a second source operand is accessed using a second micro-operation. The first micro-operation and the second micro-operation are interlocked. Contents of the memory word location are compared. A third source operand is stored to the memory word location addressed by the second source operand. The storing is based on a match of the comparing.

A block diagram for atomic compare and swap using micro-operations is shown. The block diagram 300 includes a processor core 310. The processor core can be accessed for processing an operation such as an atomic compare and swap (CAS) operation. The atomic compare and swap operation can include an Atomic Memory Operation Compare And Swap (AMOCAS) operation. The processor core can include one or more elements that support atomic CAS operations. In embodiments, the processor core can include an execution pipeline (not shown), wherein the execution pipeline is configured to execute micro-operations. The micro-operations can result from splitting a CAS operation into a plurality of micro-operations. The processor core can include a decoding and issuing stage 320. The decoding and issuing stage can accomplish one or more tasks associated with executing an atomic compare and swap operation. The tasks can include decoding and issuing a CAS instruction 322. In embodiments, the decoding and issuing the CAS instruction can include issuing a compare and swap (CAS) instruction in the processor core. The processor core can include a RISC-V™ processor core. In embodiments, the CAS instruction necessitates three source operands, wherein one of the source operands includes a destination register. The other operations can include a first memory location and a second memory location. The processor core includes a splitting stage 330. The splitting stage can perform splitting tasks. The splitting tasks can include splitting the CAS operation into a series of micro-operations 332, such as micro-operation 1, micro-operation 2, micro-operation 3, and so on.

In embodiments, the splitting, the initiating, and the completing can be accomplished by an independent state machine within the processor core. The tasks can further include receiving and processing an operation exception. In embodiments, the splitting, the initiating, and the completing can be performed by a micro-operation sequencer within a decode unit of the processor core. The micro-operation sequencer can sequence the micro-operations and accomplish other tasks associated with the micro-operations. In embodiments, the micro-operation sequencer can track execution of the series of micro-operations. The tracking can include noting which micro-operations have completed, which need to be executed, and so on. An exception can occur. In embodiments, the micro-operation sequencer can save the last successfully completed micro-operation, based on the operation exception being received. The operation exception can be processed. In embodiments, the micro-operation sequencer can restart the series of micro-operations at the first unexecuted micro-operation of the series of micro-operations, based on completion of the operation exception.

The block diagram 300 for atomic CAS using micro-operations includes an execution stage 340. The execution stage can comprise a load/store unit. The execution stage can accomplish load operations and store operations. The load and store operations can load data to be operated on by a micro-operation, store data produced by a micro-operation, and so on. The load and store operation can access storage. The storage can include local storage, shared local storage, shared system storage, and so on. In the block diagram 300, the storage can include a memory 350. The memory can include cache memory, system memory, and so on. The cache storage can include a first level (L1) cache, a multi-level cache, and the like. The load/store unit can store a first value from a memory location indicated by a first source operand into a temporary register. In the block diagram 300, the temporary register 360 can include one or more temporary registers such as temporary register 1 362, temporary register 2 363, temporary register 3 364, temporary register 4 365, and temporary register 5 366.

The execution stage 340 can perform other tasks associated with performing atomic compare and swap instructions using micro-operations. In embodiments, the execution stage can compare contents of the temporary register to contents of a destination register. Recall that the destination register can be specified by one of the three operands of the CAS instruction. The comparing can be based on a bit-wise comparison, a byte-wise comparison, and so on. In embodiments, a second value of a second source operand is assigned to the memory location indicated by the first source operand, based on a match of the comparing contents. That is, if a match is determined, then the second value is written to the address indicated by the first source operand. In further embodiments, the contents of the temporary register are stored to the destination register, based on a mismatch of the comparing contents. Thus, if the contents match, then the memory contents at the location indicated by the first source operand can be updated. If the contents do not match, the contents of the temporary register are stored to the destination register. In other words, a match of the value read from memory with the value from “rd” causes the value in the second source operand “rs2” to be written to memory. Regardless of the match result, the value read from memory is written into “rd.” In embodiments, the splitting, the storing a first value, the comparing, the assigning, and the storing the contents comprise an Atomic Memory Operation Compare And Swap (AMOCAS) instruction. Three variations of the AMOCAS instruction can be executed by the execution stage. The three various include the AMOCAS. W instruction which operates on word data (e.g., 32-bits); the AMOCAS.D instruction which operates on doubleword data (e.g., 64-bits); and the AMOCAS.Q instruction which operates on quadword data (e.g., 128-bits).

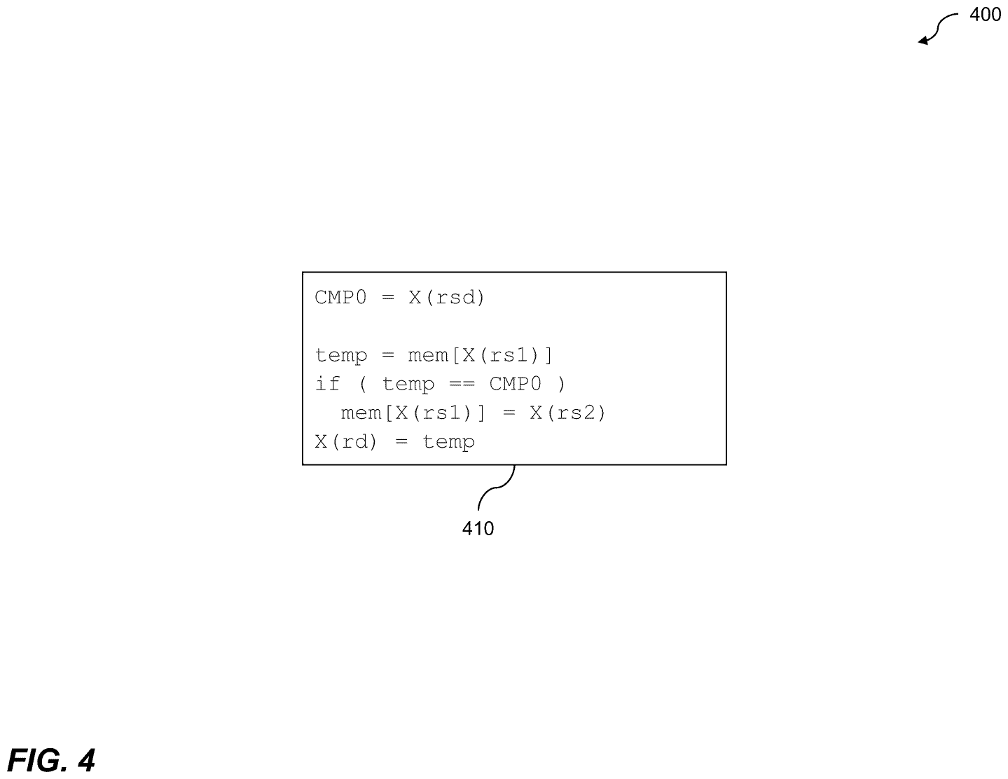

FIG. 4 illustrates example AMOCAS.W setup and implementation pseudocode. An Atomic Memory Operation Compare And Swap (AMOCAS) operation, AMOCAS.W, is an atomic CAS operation that handles data with dimensions equal to words. In a usage example, the AMOCAS. W operation can handle data sizes that include four-byte widths. The AMOCAS. W operation enables atomic compare and swap using micro-operations. The example pseudocode is suitable for AMOCAS. W instructions in a 32-bit processor architecture and for AMOCAS. W and AMOCAS.D instructions in a 64-bit processor architecture. A processor core is accessed, wherein the processor core supports atomic memory operations, and wherein the atomic memory operations include multi-operand operations. A compare and swap (CAS) instruction is issued in the processor core. The CAS instruction necessitates three source operands. One of the source operands comprises a destination register. The CAS instruction is split into a plurality of micro-operations. A first value is written from a memory location indicated by a first source operand into a temporary register. A memory word location addressed by a second source operand is accessed using a second micro-operation. The first micro-operation and the second micro-operation are interlocked. Contents of the memory word location are compared. A third source operand is stored to the memory word location addressed by the second source operand. The storing is based on a match of the comparing.

Example pseudocode is shown for an AMOCAS.W operation 400. The pseudocode 410 shows a plurality of micro-operations executed atomically. Specifically, a one line write micro-operation is followed by a four line compare and swap (CAS) operation. For atomic execution, the micro-operations are executed “all at once” from the perspective of the executing code. That is, execution of the micro-operations will complete rather than be interrupted by other instructions or micro-operations, unless an exception occurs. The AMOCAS.W can load a word value. In the example, the word value can include a 4-byte or 32-bit data value. The value of the destination register operand (rsd) of the AMOCAS.W instruction is assigned to a first temporary register, designated as CMP0, which is the compare value. Next, the value from the memory location addressed by the contents of the AMOCAS.W instruction source operand 1 (rs1) is loaded, which is the value to be compared. Note that the “temp” variable name is a pseudocode construct and not necessarily a physical register. If a match exists in the compare, then the value of AMOCAS.W instruction source operand 2 (rs2) is stored back to the memory location addressed by the contents of source operand 1, which is “mem [X(rs1)]=X(rs2).” Finally, the former contents of the memory location, again, designated as “temp,” are passed back to the AMOCAS.W instruction destination operand (rd).

For the 32-bit AMOCAS.W and the 64-bit AMOCAS.W and AMOCAS.D instructions, the micro-operation sequencer will produce the two micro-operation sequence in the order shown below:
1) MVTT
2) CAS

The behavior of these micro-operations is described below:

### UOP0: MVTT—Move to Temporary Register Micro-Operation

a. Specifies 1 source operand X(rd) which provides the compare value to be used by the CAS micro-operation
b. Implicitly identifies the destination register as CMP0—an LSU temporary register
   i. LSU will use the micro-operation sequence number to identify CMP0 as the target of the MVTT micro-operation
c. Initiates interlocking behavior
   i. The interlocking behavior prevents dispatch/issue of following instructions until the MVTT has been retired
   ii. This behavior ensures that the following CAS micro-operation is not dispatched until the CMP0 temporary registers has been updated
d. Performs the behavior shown in the pseudo-code below:

$$CMP 0 = x ( rsd )$$

### UOP1: CAS—Compare and Swap Micro-Operation

e. Specifies 2 source operands X(rs1), the base address, and X(rs2) the store data
f. Specifies a destination operand X(rd) for the load return data.
g. Initiates interlocking operation
   i. this behavior ensures any following AMOCAS instruction does not touch an LSU temporary register.
h. Performs the atomic compare and swap behavior as shown in the pseudo-code below

Note that the value shown as temp is used as a name to identify a value used in the pseudo-code and does not necessarily represent physical storage, and that CMP0 is the LSU temporary register loaded by UOP0, which is the MVTT micro-operation.

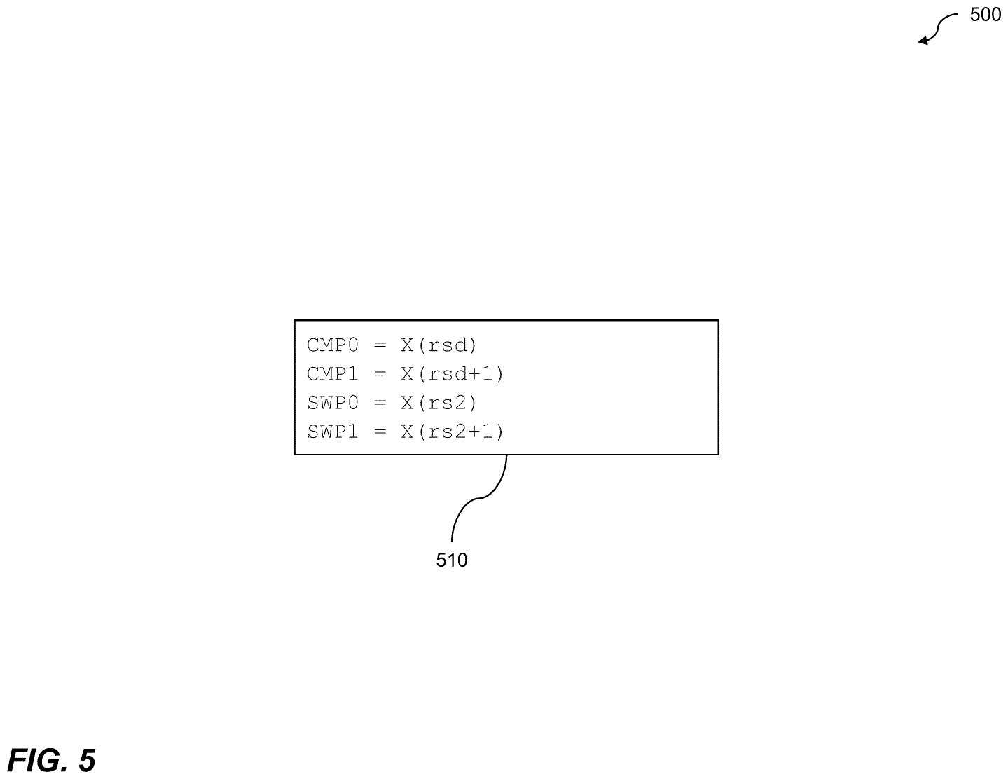

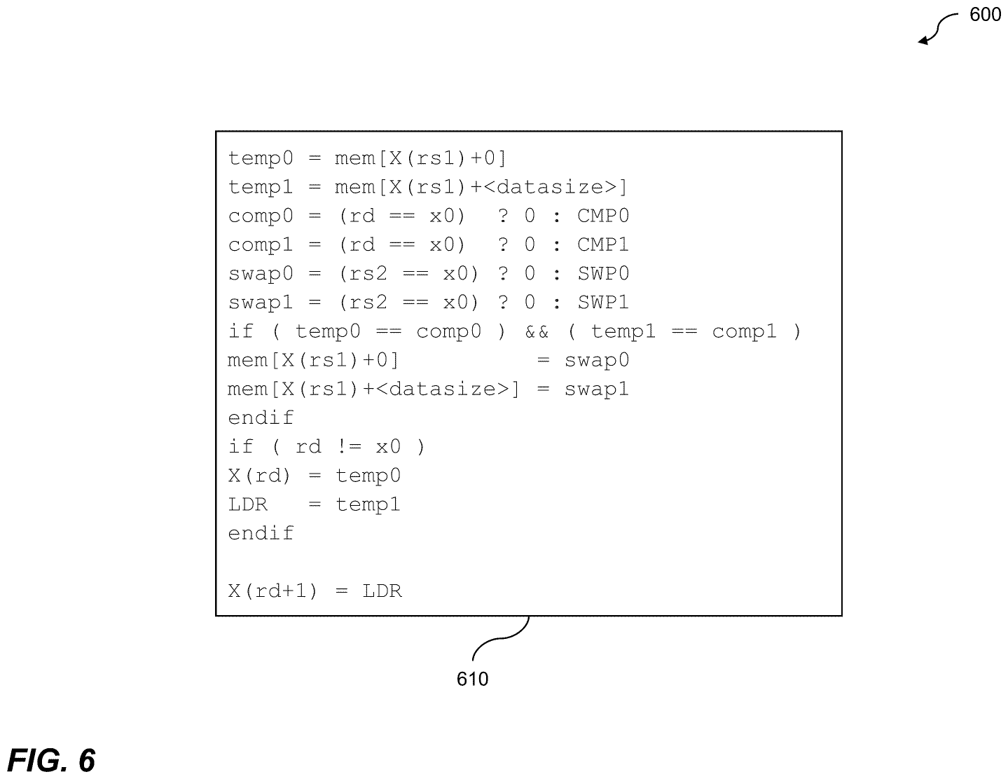

FIG. 5 shows example AMOCAS.D and AMOCAS.Q implementation setup pseudocode. The AMOCAS.D operation differs in part from the AMOCAS.W instruction discussed previously in that the AMOCAS.D instruction operates on doubleword or double precision values. In embodiments, the AMOCAS.D instruction operates on 64-bit numbers comprising eight bytes. When the AMOCAS.D instruction is executed on a 32-bit architecture processor, the 64-bit data chunks must be handled in two steps. Likewise, the AMOCAS.Q instruction, which operates on 128-bit, or 16-byte, data chunks is executed on a 64-bit architecture processor, and the 128-bit data chunks must be handled in two steps. The implementation setup pseudocode of FIG. 5 and the implementation pseudocode of FIG. 6 enable wide AMOCAS.D and AMOCAS.Q instructions to be executed on processors with narrower data paths, which supports atomic compare and swap using micro-operations. The example 500 shows implementation setup pseudocode 510 for the AMOCAS.D and AMOCAS.Q instructions. The implementation setup pseudocode 510 includes micro-operations to write the value of the instruction destination operand (rsd) and the value of the next data chunk associated with rsd, designated (rsd+1), into temporary registers CMP0 and CMP1, respectively. Then, similarly, the value found in the instruction source operand 2 (rs2) and the value of the next data chunk associated with rs2, designated (rs2+1), are written into temporary registers SWP0 and SWP1, respectively. Note that the pseudocode can indicate the next chunk of data simply by designating “+1” for these simple “move to” (write) operations.

FIG. 6 illustrates example AMOCAS.D and AMOCAS.Q implementation execution pseudocode. The pseudocode 610 in example 600 shows an eleven-line implementation of a CAS micro-operation and a one-line implementation of a final write operation to enable atomic compare and swap using micro-operations. The CAS micro-operation begins by loading the value from the memory location designated by AMOCAS instruction source operand 1 (rs1) in two chunks into pseudocode variables temp0 and temp1. As mentioned previously, the variables in the pseudocode do not necessarily reflect physical registers. Note that in this example, the next chunk of data is designated explicitly by the variable <datasize>, which would be four for an AMOCAS.D instruction and eight for an AMOCAS.Q instruction. Next, the compare and swap is performed, which involves the data written into the four temporary registers CMP0, CMP1, SWP0, and SWP1, as described above. Finally, assuming a successful match, the AMOCAS instruction destination operand is updated: the first chunk by the CAS micro-operation itself, designated by X(rd)=temp0, and the second chunk by the CAS micro-operation writing the second chunk into a fifth temporary register, LDR, which is subsequently written out by the concluding “move from” micro-operation, designated by X(rd+1)=LDR.

For these 32-bit AMOCAS.D and 64-bit AMOCAS.Q instructions, the micro-operation sequencer will produce a six micro-operation sequence:
1. MVTT
2. MVTT
3. MVTT
4. MVTT
5. CAS
6. MVFT
   The behavior of these micro-operations is described below:

### UOP0: MVTT—Move to Temporary Register Micro-Operation

a. Specifies 1 source operand
   ii. First ½ Compare value—X(rd)
b. Destination register is an LSU temporary register—CMP0
   iii. LSU identifies CMP0 by the micro-operation sequence number
c. Performs the behavior as shown in the pseudo-code below

$$CMP 0 = x ( rd )$$

### UOP1: MVTT—Move to Temporary Register Micro-Operation

d. Specifies 1 source operand
   iv. Second ½ compare value—X(rd+1)
e. Destination register is an LSU temporary register-CMP1
   v. LSU identifies CMP1 is identified by the micro-operation sequence number
f. Performs the behavior as shown in the pseudo-code below

$$CMP 1 = x ( rd + 1 )$$

### UOP2: MVTT—Move to Temporary Register Micro-Operation

g. Specifies 1 source operand
   vi. First ½ swap value—X(rs2)
h. Destination register is an LSU temporary register—SWP0
   vii. LSU identifies SWP0 by the micro-operation sequence number
i. Performs the behavior as shown in the pseudo-code below

$$SWP 0 = X ( rs 2 )$$

### UOP3: MVTT—Move to Temporary Register Micro-Operation

j. Specifies 1 source operand
   viii. Second ½ swap value—X(rs2+1)
k. Destination register is an LSU temporary register—SWP1
   ix. LSU identifies SWP1 by the micro-operation sequence number
   x. Performs interlocking operation
      1. To ensure CAS micro-operation is not dispatched until all temporary registers have been updated
l. Performs the behavior as shown in the pseudo-code below

$$SWP 1 = X ( rs 2 + 1 )$$

### UOP4: CAS—Compare and Swap Micro-Operation

m. Specifies 2 source operands X(rs1), the base address, and X(rs2) the store data
n. Specifies a destination operand X(rd) for the load return data.
o. Writes back first half of load return data into X(rd) and the second half into a temporary register-LDR
p. Performs interlocking operation
   xi. To ensure following MVFT does not dispatch before the CAS has completed.
q. Performs the atomic compare and swap behavior as shown in the pseudocode 610.

Note that the values shown as temp0, temp1, comp0, comp1, swap0, and swap1 are used as names to identify values used in the pseudo-code and do not necessarily represent physical storage, and that CMP0, CMP1, SWP0 and SWP1 are the LSU temporary registers loaded by the previous micro-operations in the sequence.

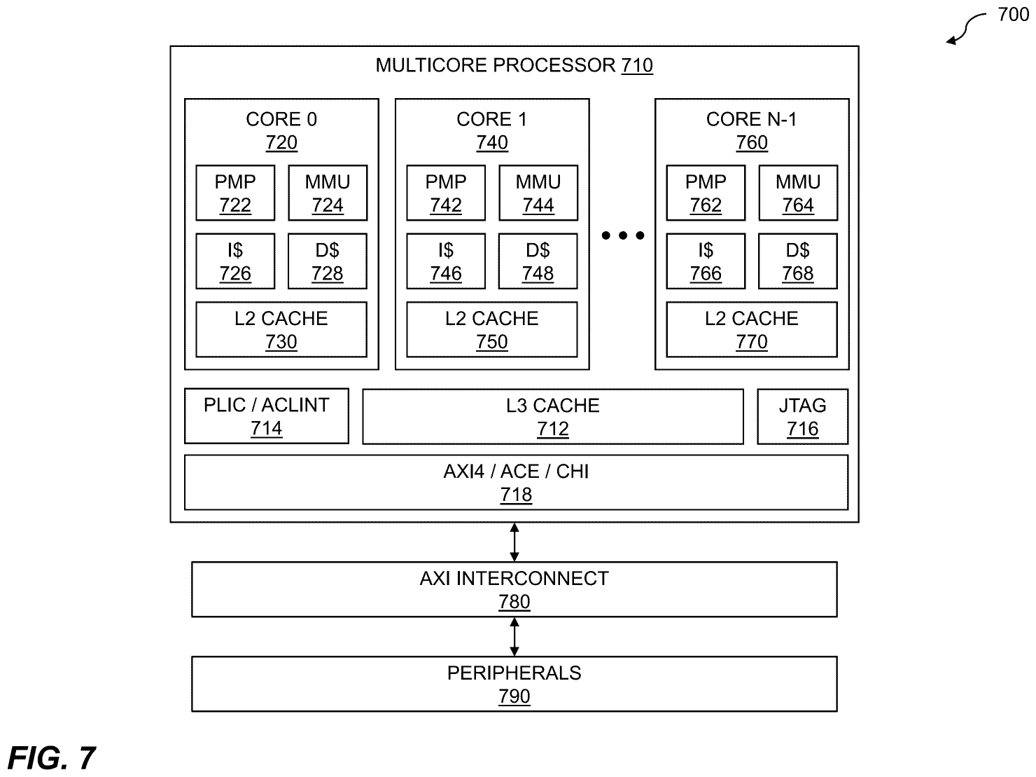

FIG. 7 is a block diagram illustrating a multicore processor. The processor, such as a RISC-V™ processor, ARM processor, or other suitable processor type, can include a variety of elements. The elements can include processor cores including multiprocessor cores, one or more caches, shared memory, memory protection and management units, local storage, and so on. In embodiments, the processor core sequences atomic operations using micro-operations. The elements of the multicore processor can further include one or more of a private cache; a test interface such as a joint test action group (JTAG) test interface; one or more interfaces to a network such as a network-on-chip, shared memory, and peripherals; and the like. The multicore processor enables atomic compare and swap using micro-operations. A processor core is accessed. The processor core supports atomic memory operations. The atomic memory operations include multi-operand operations. A compare and swap (CAS) instruction is issued in the processor core. The CAS instruction necessitates three source operands. One of the source operands comprises a destination register. The CAS instruction is split into a plurality of micro-operations. A first value is written from a memory location indicated by a first source operand into a temporary register. A memory word location addressed by a second source operand is accessed using a second micro-operation. The first micro-operation and the second micro-operation are interlocked. Contents of the memory word location are compared. A third source operand is stored to the memory word location addressed by the second source operand. The storing is based on a match of the comparing.

In the block diagram 700, the multicore processor 710 can comprise two or more processors, where the two or more processors can include homogeneous processors, heterogeneous processors, etc. In the block diagram, the multicore processor can include N processor cores such as core 0 720, core 1 740, core N−1 760, and so on. Each processor can comprise one or more elements. In embodiments, each core, including cores 0 through core N−1 can include a physical memory protection (PMP) element, such as PMP 722 for core 0; PMP 742 for core 1, and PMP 762 for core N−1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 724 for core 0, MMU 744 for core 1, and MMU 764 for core N−1. The memory management units can translate virtual addresses used by software running on the cores to physical memory addresses within caches, the shared memory system, etc.

The processor cores associated with the multicore processor 710 can include caches such as instruction caches and data caches. The caches, which can comprise level 1 (L1) caches, can include an amount of storage such as 16 KB, 32 KB, and so on. The caches can include an instruction cache I$ 726 and a data cache D$ 728 associated with core 0; an instruction cache I$ 746 and a data cache D$ 748 associated with core 1; and an instruction cache I$ 766 and a data cache D$ 768 associated with core N−1. In addition to the level 1 instruction and data caches, each core can include a level 2 (L2) cache. The level 2 caches can include L2 cache 730 associated with core 0; L2 cache 750 associated with core 1; and L2 cache 770 associated with core N−1. The cores associated with the multicore processor 710 can include further components or elements. The further elements can include a level 3 (L3) cache 712. The level 3 cache, which can be larger than the level 1 instruction and data caches and the level 2 caches associated with each core, can be shared among all of the cores. The further elements can be shared among the cores. In embodiments, the further elements can include a platform level interrupt controller (PLIC) 714. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 716. The JTAG can provide a boundary within the cores of the multicore processor. The JTAG can enable fault information to a high precision. The high-precision fault information can be critical to rapid fault detection and repair.

The multicore processor 710 can include one or more interface elements 718. The interface elements can support standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 700, the interface elements can be coupled to the interconnect. The interconnect can include a bus, a network, and so on. The interconnect can include an AXI™ interconnect 780. In embodiments, the network can include network-on-chip functionality. The AXI™ interconnect can be used to connect memory-mapped “master” or boss devices to one or more “slave” or worker devices. In the block diagram 700, the AXI interconnect can provide connectivity between the multicore processor 710 and one or more peripherals 790. The one or more peripherals can include storage devices, networking devices, and so on. The peripherals can enable communication using the AXI™ interconnect by supporting standards such as AMBA™ version 4, among other standards.

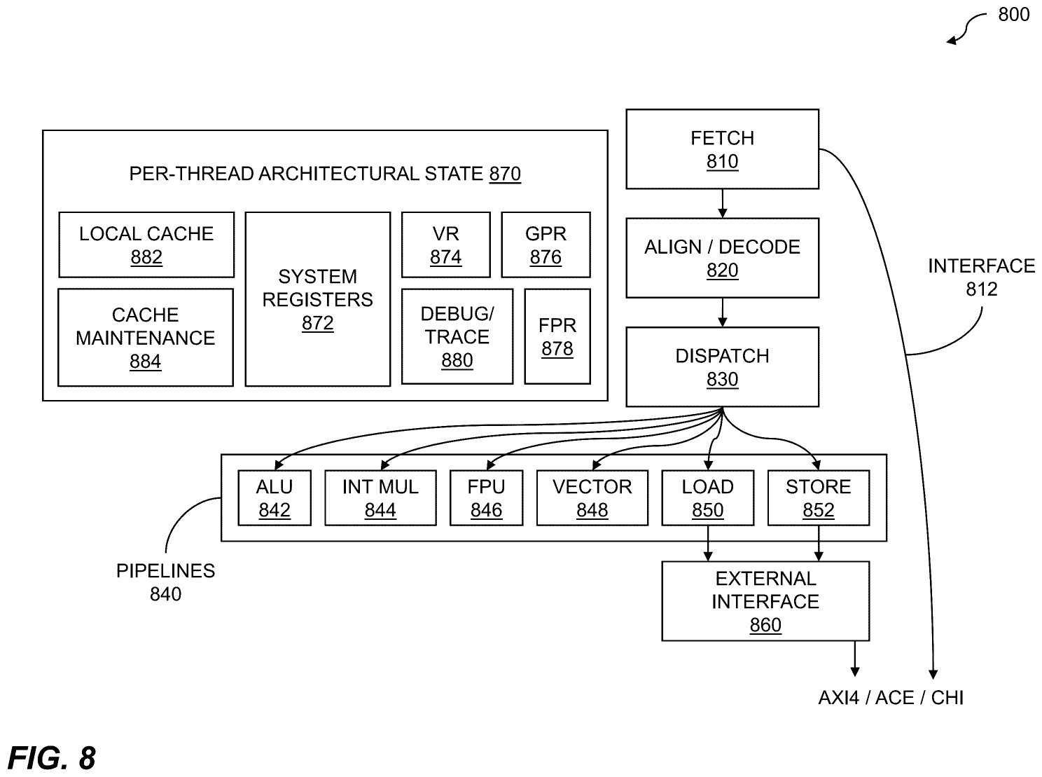

FIG. 8 is a block diagram 800 for a pipeline. The use of one or more pipelines associated with a processor architecture can greatly enhance processing throughput. The processor architecture can be associated with one or more processor cores. The processing throughput can be increased because multiple operations can be executed in parallel. In embodiments, a processor core is accessed, where the processor core supports atomic memory operations. The atomic operations include atomic compare and swap using micro-operations. A processor core is accessed. The processor core supports atomic memory operations. The atomic memory operations include multi-operand operations. A compare and swap (CAS) instruction is issued in the processor core. The CAS instruction necessitates three source operands. One of the source operands comprises a destination register. The CAS instruction is split into a plurality of micro-operations. A first value is written from a memory location indicated by a first source operand into a temporary register. A memory word location addressed by a second source operand is accessed using a second micro-operation. The first micro-operation and the second micro-operation are interlocked. Contents of the memory word location are compared. A third source operand is stored to the memory word location addressed by the second source operand. The storing is based on a match of the comparing.

The blocks within the block diagram can be configurable in order to provide varying processing levels. The varying processing levels can be based on processing speed, bit lengths, numbers of micro-operations, and so on. The block diagram 800 can include a fetch block 810. The fetch block 810 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 812. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 800 includes an align and decode block 820. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 800 can include a dispatch block 830. The dispatch block can receive decoded instruction packets from the align and decode block. The decoded instruction packets can be used to control a pipeline 840, where the pipeline can include an in-order pipeline, an out-of-order (OoO) pipeline, etc. In embodiments, the processor core executes one or more instructions out of order. A pipeline can be associated with the one or more execution units. The pipelines associated with the execution units can include processor cores, arithmetic logic unit (ALU) pipelines 842, integer multiplier pipelines 844, floating-point unit (FPU) pipelines 846, vector unit (VU) pipelines 848, and so on. The dispatch unit can further dispatch instructions to pipelines that can include load pipelines 850, and store pipelines 852. The load pipelines and the store pipelines can access storage such as the common memory using an external interface 860. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 870. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 872. The system registers can be associated with individual processors, a system comprising multiple processors, and so on. The system registers can include exception and interrupt components, counters, etc. The per-thread architectural state can include further registers such as vector registers (VR) 874. The vector registers can be grouped in a vector register file and can be used for vector operations. In embodiments, the width of the vector register file is 512 bits. Additional registers such as general-purpose registers (GPR) 876 and floating-point registers (FPR) 878 can be included. These registers can be used for general purpose (e.g., integer) operations, and floating-point operations, respectively. The per-thread architectural state can include a debug and trace block 880. The debug and trace block can enable debug and trace operations to support code development, troubleshooting, and so on. In embodiments, an external debugger can communicate with a processor through a debugging interface such as a joint test action group (JTAG) interface. The per-thread architectural state can include a local cache state 882. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 884. The cache maintenance state can include maintenance needed, maintenance pending, maintenance complete, etc.

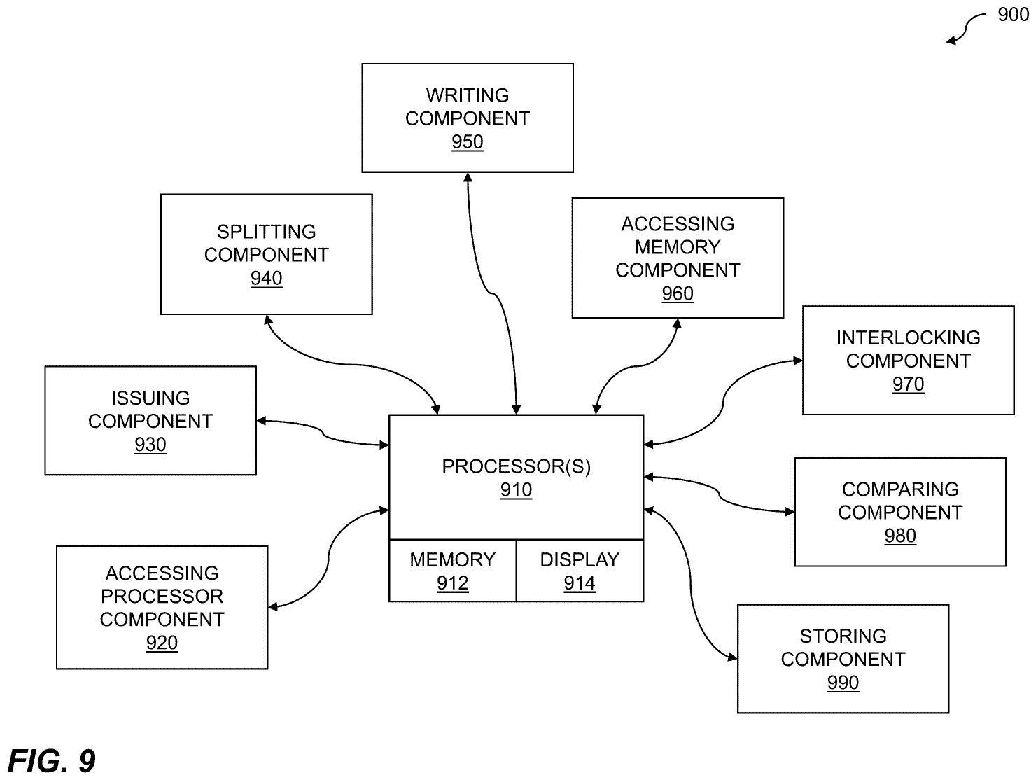

FIG. 9 is a system diagram for atomic compare and swap using micro-operations. The system 900 can include instructions and/or functions for design and implementation of integrated circuits that support atomic compare and swap using micro-operations. The system 900 can include instructions and/or functions for generation and/or manipulation of design data such as hardware description language (HDL) constructs for specifying structure and operation of an integrated circuit. The system 900 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 900 can include one or more processors 910. The processors can include standalone processors within integrated circuits or chips, processor cores in FPGAs or ASICs, and so on. The one or more processors 910 are coupled to a memory 912, which stores operations. The memory can include one or more of local memory, cache memory, system memory, etc. The system 900 can further include a display 914 coupled to the one or more processors 910. The display 914 can be used for displaying data, instructions, operations, micro-operations, and the like. The operations can include instructions and functions for implementation of integrated circuits, including processor cores. In embodiments, the processor cores can include RISC-V™ processor cores. A system comprising the one or more processors 910, when executing the instructions which are stored in the memory 912, are configured to: access a processor core, wherein the processor core supports atomic memory operations, and wherein the atomic memory operations include multi-operand operations; issue a compare and swap (CAS) instruction, in the processor core, wherein the CAS instruction includes three source operands, and wherein one of the source operands comprises a destination register; split the CAS instruction into a plurality of micro-operations; write a first value from the destination register indicated by a first source operand into a temporary register using a first micro-operation; access a memory word location addressed by a second source operand using a second micro-operation; interlock the first micro-operation and the second micro-operation; compare the temporary register to contents of the memory word location addressed by a second source operand, based on the interlocking; and store a third source operand to a memory word location addressed by the second source operand, based on a match of the comparing.

The system 900 can include an accessing processor component 920. The accessing processor component 920 can include functions and instructions for accessing a processor core. The processor core can include an ARM core, a MIPS core, and/or other suitable core type. In embodiments, the processor core can include a RISC-V™ architecture. The processor core can include a processor core within a plurality of processor cores. The processor core supports atomic memory operations. The RISC-V™ architecture can include extensions, where the extensions can enable execution of various arithmetic and logic operations. In embodiments, RISC-V™ architecture can include extensions that enable the atomic memory operations including multi-operand operations. The operands can be associated with an atomic compare and swap (AMOCAS) instruction (discussed below).

The system 900 can include an issuing component 930. The issuing component 930 can include functions and instructions for issuing an atomic compare and swap (AMOCAS) instruction, in the processor core, wherein the AMOCAS instruction necessitates three source operands, wherein one of the source operands comprises a destination register. The other operands, such as a first operand and a second operand, can include memory addresses, register values, and so on. The AMOCAS instruction can be used for synchronization of two or more sequences of instructions executing in a multithreaded environment. The AMOCAS instruction can compare contents of a memory location to a value. If the contents of the memory location and the value are equal, then the memory location can be assigned a new value. Otherwise, the contents of the memory location can remain at the current value present in the memory location. In embodiments, the AMOCAS instruction can be executed as an atomic operation. By executing the AMOCAS instruction as an atomic operation, a new value that is calculated and assigned to the memory location is based on the most current or “up-to-date” data. The processor core can include an execution pipeline, where the execution pipeline can be configured to execute micro-operations. The micro-operations can include accessing a memory, a vector register, a starting address for data, a source register, a destination register, and so on.

The system 900 can include a splitting component 940. The splitting component 940 can include functions and instructions for splitting the CAS instruction into a plurality of micro-operations. In embodiments, the plurality of micro-operations can be issued from a single load issue queue. The load issue queue can issue micro-operations to the processor core. In embodiments, the one or more micro-operations can be performed atomically. The one or more micro-operations can be executed atomically if the code from which the micro-operations are split can be linearized such that access to a shared object, such as contents of memory, can be performed without risk of one access to the shared object changing the shared object before another access can be completed. A micro-operation can include a memory access, an arithmetic operation, a logical operation, etc. In embodiments, the one or more micro-operations can be forced to execute in order. One or more micro-operations can be associated with each instruction or operation. Executing micro-operations in order forces the micro-operations to proceed, thereby completing execution of the operation with which the micro-operations are associated.

The system 900 can include a writing component 950. The writing component 950 can include functions and instructions for writing a first value from an AMOCAS instruction operand to a temporary register. The temporary register can include a temporary register within a processor core, a shared temporary register that can be shared among a plurality of processors within a multiprocessor, and so on. In embodiments, the temporary register is located within a Load-Store Unit (LSU). Some embodiments include multiple temporary registers. In embodiments, the first source operand can provide address alignment based on an operand size of the AMOCAS instruction. The alignment can be to a word edge, a doubleword edge, and so on. In embodiments, the writing a first value can be based on a first micro-operation. The first micro-operation can include a move micro-operation. In embodiments, the first micro-operation can include a Move To Temporary Register (MVTT) micro-operation.

The system 900 can include an accessing memory component 960. The accessing memory component 960 can include functions and operations for loading the contents of a memory location, as specified by a source operand of the AMOCAS instruction. The system 900 can include an interlocking component 970. The interlocking component 970 can include interlocking micro-operations to maintain instruction atomicity and integrity. The interlocking can comprise a post-MVTT synchronization behavior that prevents the dispatch and/or the issue of the second micro-operation until the (final) MVTT micro-operation is retired or completed. This ensures that any/all involved temporary registers have been updated before the ensuing CAS operation executes.

The system 900 can include a comparing component 980. The comparing component can include determining that the contents of the temporary register are substantially similar or substantially dissimilar. The comparing can be based on a bit-by-bit comparison, a byte-by-byte comparison, and so on. The comparing typically involves determining an exact match, but the comparing could be based on a partial match. The system 900 can include a storing component 990. The storing component 990 can include functions and micro-operations for assigning the value of a second source operand of the AMOCAS instruction to the memory location indicated by the first source operand, based on a match of from the comparing component 980. The storing effects a swap of the AMOCAS instruction second source operand into the memory location indicated by the AMOCAS instruction first source operand. The storing can be based on the CAS micro-operation determining that the contents of the location indicated by the AMOCAS instruction first source operand and the value of the AMOCAS instruction destination operand match. The matching can indicate that the synchronization of two or more threads executing in the processor core has been achieved.

In embodiments, the splitting, the storing a first value, the comparing, the assigning, and the storing the contents comprise an Atomic Memory Operation Compare And Swap Word (AMOCAS.W) instruction. The AMOCAS. W instruction can operate on a full word of data. The word of data can include four bytes. Other embodiments include storing a second value from an additional memory location indicated by a first source operand plus an offset into an additional temporary register, based on a CAS instruction comprising a CAS instruction operating on greater than word data. An offset can include a number of bytes associated with the data. The number of bytes can describe a data size. The offset can be associated with data represented by a doubleword, a quadword, etc. In embodiments, the offset of the additional memory location is four bytes beyond the address of the memory location, based on the CAS instruction comprising a doubleword CAS instruction. The additional four bytes can be associated with a doubleword data representation. In other embodiments, the offset of the additional memory location is eight bytes beyond the address of the memory location, based on the CAS instruction comprising a quadword CAS instruction. The eight bytes plus the original four bytes can be associated with an extended data size representation. In embodiments, the offset of the additional memory location is four addresses beyond the address of the memory location, based on the CAS instruction comprising an Atomic Memory Operation Compare And Swap Doubleword (AMOCAS.D) instruction. In embodiments, the offset of the additional memory location is eight addresses beyond the address of the memory location, based on the CAS instruction comprising an Atomic Memory Operation Compare And Swap Doubleword (AMOCAS.Q) instruction.

The system 900 can include a computer program product embodied in a non-transitory computer readable medium for instruction execution, the computer program product comprising code which causes one or more processors to generate semiconductor logic for: accessing a processor core, wherein the processor core supports atomic memory operations, and wherein the atomic memory operations include multi-operand operations; issuing a compare and swap (CAS) instruction, in the processor core, wherein the CAS instruction includes three source operands, and wherein one of the source operands comprises a destination register; splitting the CAS instruction into a plurality of micro-operations; writing a first value from the destination register indicated by a first source operand into a temporary register using a first micro-operation; accessing a memory word location addressed by a second source operand using a second micro-operation; interlocking the first micro-operation and the second micro-operation; comparing the temporary register to contents of the memory word location addressed by a second source operand, based on the interlocking; and storing a third source operand to a memory word location addressed by the second source operand, based on a match of the comparing.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for instruction execution comprising:
accessing a processor core, wherein the processor core supports atomic memory operations, and wherein the atomic memory operations include multi-operand operations;
issuing a compare and swap (CAS) instruction, in the processor core, wherein the CAS instruction includes three source operands, and wherein one of the source operands comprises a destination register;
splitting the CAS instruction into a plurality of micro-operations;
writing a first value from the destination register indicated by a first source operand into a temporary register using a first micro-operation;
accessing a memory word location addressed by a second source operand using a second micro-operation;
interlocking the first micro-operation and the second micro-operation;
comparing the temporary register to contents of the memory word location addressed by a second source operand, based on the interlocking; and
storing a third source operand to a memory word location addressed by the second source operand, based on a match of the comparing.

2. The method of claim 1 wherein the first micro-operation comprises a Move To Temporary Register (MVTT) micro-operation.

3. The method of claim 2 wherein the second micro-operation comprises a Compare And Swap (CAS) micro-operation.

4. The method of claim 3 wherein the interlocking prevents dispatch of the second micro-operation, based on the MVTT micro-operation being completed.

5. The method of claim 4 wherein the MVTT micro-operation being retired ensures the temporary register has been successfully updated by the first micro-operation.

6. The method of claim 4 further comprising inhibiting dispatch of micro-operations supporting an additional compare and swap instruction, based on the CAS micro-operation being completed.

7. The method of claim 6 wherein the inhibiting dispatch of micro-operations supporting the additional compare and swap instruction maintains integrity of the temporary register.

8. The method of claim 7 wherein the interlocking and the inhibiting enable atomicity of the micro-operations comprising the compare and swap instruction.

9. The method of claim 1 wherein the splitting, the writing, the accessing, the interlocking, the comparing, and the storing comprise an Atomic Memory Operation Compare And Swap Word (AMOCAS.W) instruction.

10. The method of claim 1 further comprising writing an additional value from a memory location indicated by the first source operand plus an offset into an additional temporary register, based on a CAS instruction comprising a CAS instruction operating on greater than word data.

11. The method of claim 10 wherein the offset of the additional memory location is four addresses beyond the address of the memory location, based on the CAS instruction comprising an Atomic Memory Operation Compare And Swap Doubleword (AMOCAS.D) instruction.

12. The method of claim 10 wherein the offset of the additional memory location is eight addresses beyond the address of the memory location, based on the CAS instruction comprising an Atomic Memory Operation Compare And Swap Doubleword (AMOCAS.Q) instruction.

13. The method of claim 10 wherein the writing a first value and the writing an additional value comprise two Move To Temporary register (MVTT) micro-operations.

14. The method of claim 13 further comprising following the writing a first value and the writing a second value with two additional MVTT micro-operations.

15. The method of claim 14 wherein the two additional MVTT micro-operations write a split third source operand into two additional temporary registers.

16. The method of claim 15 further comprising following the two additional MVTT micro-operations with the second micro-operation, which comprises a Compare And Swap (CAS) micro-operation.

17. The method of claim 16 wherein the CAS micro-operation is inhibited until the two additional MVTT micro-operations are completed.

18. The method of claim 16 further comprising issuing a Move From Temporary register (MVFT) micro-operation following the CAS micro-operation.

19. The method of claim 18 wherein the MVFT micro-operation ensures successful completion of the CAS micro-operation before execution of the MVFT micro-operation.

20. The method of claim 18 wherein the MVFT micro-operation uses a further additional temporary register.

21. The method of claim 1 wherein the first source operand provides address alignment based on an operand size of the CAS instruction.

22. The method of claim 1 wherein the plurality of micro-operations is issued to a single load issue queue.

23. A computer program product embodied in a non-transitory computer readable medium for instruction execution, the computer program product comprising code which causes one or more processors to generate semiconductor logic for:
accessing a processor core, wherein the processor core supports atomic memory operations, and wherein the atomic memory operations include multi-operand operations;
issuing a compare and swap (CAS) instruction, in the processor core, wherein the CAS instruction includes three source operands, and wherein one of the source operands comprises a destination register;
splitting the CAS instruction into a plurality of micro-operations;
writing a first value from the destination register indicated by a first source operand into a temporary register using a first micro-operation;
accessing a memory word location addressed by a second source operand using a second micro-operation;
interlocking the first micro-operation and the second micro-operation;
comparing the temporary register to contents of the memory word location addressed by a second source operand, based on the interlocking; and
storing a third source operand to a memory word location addressed by the second source operand, based on a match of the comparing.

24. A computer system for instruction execution comprising:
a memory which stores instructions;
one or more processors coupled to the memory, wherein the one or more processors, when executing the instructions which are stored, are configured to:
access a processor core, wherein the processor core supports atomic memory operations, and wherein the atomic memory operations include multi-operand operations;
issue a compare and swap (CAS) instruction, in the processor core, wherein the CAS instruction includes three source operands, and wherein one of the source operands comprises a destination register;
split the CAS instruction into a plurality of micro-operations;
write a first value from the destination register indicated by a first source operand into a temporary register using a first micro-operation;
access a memory word location addressed by a second source operand using a second micro-operation;
interlock the first micro-operation and the second micro-operation;
compare the temporary register to contents of the memory word location addressed by a second source operand, based on the interlocking; and
store a third source operand to a memory word location addressed by the second source operand, based on a match of the comparing.
